(19) United States
(12) Patent Application Publication
(10) Pub. No.: US 2026/0212311 A1
(43) Pub. Date: Jul. 23, 2026

(54) Supply Chain Tracking System

(71) Applicant: T2GREEN LLC, Oro Valley, AZ (US)

(72) Inventor: David Guner Gardenhire, Fort Collins, CO (US)

(73) Assignee: T2GREEN LLC, Oro Valley, AZ (US)

(21) Appl. No.: 19/028,007

(22) Filed: Jan. 17, 2025

(51) Int. Cl. G06Q 10/0833

(52) U.S. Cl. CPC G06Q 10/0833

(57) ABSTRACT

A computer implemented supply chain asset tracking system and methods of making and using the computer implemented supply chain asset tracking system to increase asset information flow associated with one or more assets in or between a plurality of tiers in a supply chain.

### I. FIELD OF THE INVENTION

A computer implemented supply chain asset tracking system and methods of making and using the computer implemented supply chain asset tracking system to increase asset information flow associated with one or more assets in or between a plurality of tiers in a supply chain.

### II. BACKGROUND OF THE INVENTION

In a multi-tier supply chain, no one entity may be involved in more than one tier of a plurality of tiers in a supply chain. In the client tier of a supply chain, the client may associate a unique asset identification number with an asset manufactured in the manufacturer tier of the supply chain. In the manufacturer tier of a supply chain, the manufacturer may further create a unique asset identification number for each asset it manufactures for a client. In the distributor tier of a supply chain, the distributor receiving the asset from the manufacturer may further create a unique asset identification number for each asset distributed to a retailer. In the retailer tier of the supply chain, the retailer receiving the asset from the distributor may further create a unique asset identification number for each asset it places in-market. As between the client, the manufacturer, the distributor, and the retailer, the identification numbers associated with an asset can be all be different and asset information flow associated with the movement of the asset between tiers in the supply chain can be limited and may be insufficient to track movement or the lack of movement of an asset between tiers in a supply chain.

As result, each tier within a multi-tier system can be blind as to the location of an asset at every other tier within plurality of tiers in the supply chain. This can result in the delay in transferring assets between the tiers of a multi-tier supply chain or identifying a loss of the asset within a multi-tier supply chain. This may result in the unnecessary depletion of inventory available at any one or more of the tiers within the multi-tier system or the failure to meet in-market deadlines for the asset.

There would be a substantial advantage in a computer implemented system that allows one or more of the client, the manufacturer, the distributor, or retailer to view a common asset information flow associated with the movement of an asset in and between tiers of a supply chain. The asset information flow can allow each tier within a multi-tier supply chain to monitor current inventory and depletion of inventory for each asset at each tier in a multi-tier system, determine frequency, amount, and location of each asset transferred between tiers in the multi-tier system. The increase in asset information flow at each tier in the multi-tier system can correspondingly increase asset movement between tiers of the supply chain along with the corresponding increase in financial flow, increase in value flow, and decrease risk flow in or between tiers in a multi-tier system.

### III. SUMMARY OF THE INVENTION

A broad object of embodiments of the invention can be provision of a supply chain asset tracking system to increase asset information flow in or between tiers of a supply chain including an asset integrated with an asset tracker, wherein the asset tracker includes an asset tracker code scannable with a code reader and a processor communicatively coupled to a non-transitory computer readable medium containing an asset tracking program executable to: generate code scan data based on the asset tracker code; obtain global positioning data from a global positioning system; associate the global positioning data with the code scan data; display a graphical user interface on a display surface of a user computing device, wherein the graphical user interface includes a geographic representation of a coordinate encoded geographic space including a coordinate location indicator disposed in the geographic representation at a coordinate location of the asset based on the global positioning data, and wherein the asset tracking program is further executable to extract asset tracker entity data from the code scan data; display an asset tracker dashboard; and populate the asset tracker dashboard with the asset tracker entity data.

Another broad object of embodiments of the invention can be a method of making a supply chain asset tracking system, including producing an asset tracker integrable with an asset, wherein the asset tracker includes a code scannable with a code reader; communicatively coupling a processor to a non-transitory computer readable medium containing an asset tracking program executable to: generate code scan data based on scan of the code included in the asset tracker; obtain global positioning data from a global positioning system; associate the global positioning data with the code scan data; display a graphical user interface on a display surface of a user computing device, wherein the graphical user interface includes: a geographic representation of a coordinate encoded geographic space; a coordinate location indicator disposed in the geographic representation at a coordinate location of the asset based on the global positioning data; wherein the asset tracking program is further executable to: extract asset tracker entity data from the code scan data; display an asset tracker dashboard; and populate the asset tracker dashboard with the asset tracker entity data.

Another broad object of embodiments of the invention can be a method of asset tracking in a supply chain, including integrating an asset tracker with an asset, wherein the asset tracker includes a code scannable with a code reader; operating a client user computing device including a processor communicatively coupled to a non-transitory computer readable medium containing an asset tracking program; generating a code scan data based on a scan of the code included in the tracker; obtaining global positioning data from a global positioning system; associating the global positioning data with the code scan data; displaying a graphical user interface on a display surface of a user computing device, including: a geographic representation of a coordinate encoded geographic space; a coordinate location indicator disposed in said geographic representation at a coordinate location of said asset based on said global positioning data; extracting asset tracker entity data from said code scan data; displaying an asset tracker dashboard; and populating said asset tracker dashboard with said asset tracker entity data.

Naturally, further objects of the invention are disclosed throughout other areas of the specification, drawings, photographs, and claims.

### IV. BRIEF DESCRIPTION OF THE DRAWINGS

FIG. 1 depicts a block flow diagram of a particular embodiment of the inventive asset tracking system.

FIG. 2 illustrates a graphical user interface generated by the system including a geospatial representation of a geographic area including coordinate location indicators depicted in the geospatial representation based on global positioning data associated with the code scan data received upon scanning the code on asset tracker tag along with a dashboard configured to depict asset information flow associated with movement of assets between a plurality of tiers in a supply chain.

FIG. 3 is an illustration of a tracker tag integrated with an asset being scanned to associate code scan data with the current GPS coordinate location.

FIG. 4 depicts a block flow diagram which illustrates implementation of the supply chain asset tracking system to increase asset information flow associated with movement of assets between a plurality of tiers in a supply chain.

FIG. 5A is an enlarged portion of FIG. 4 which illustrates implementation of the supply chain asset tracking system in the client tier.

FIG. 5B is an enlarged portion of FIG. 4 which illustrates implementation of the supply chain asset tracking system in the manufacturer tier.

FIG. 5C is an enlarged portion of FIG. 4 which illustrates implementation of the supply chain asset tracking system in the distributor tier.

FIG. 5D is an enlarged portion of FIG. 4 which illustrates implementation of the supply chain asset tracking system in the retailer tier.

FIG. 6 is an illustrative example of an asset in the form of a point of sale display placed in-market by a retailer.

### V. DETAILED DESCRIPTION OF THE INVENTION

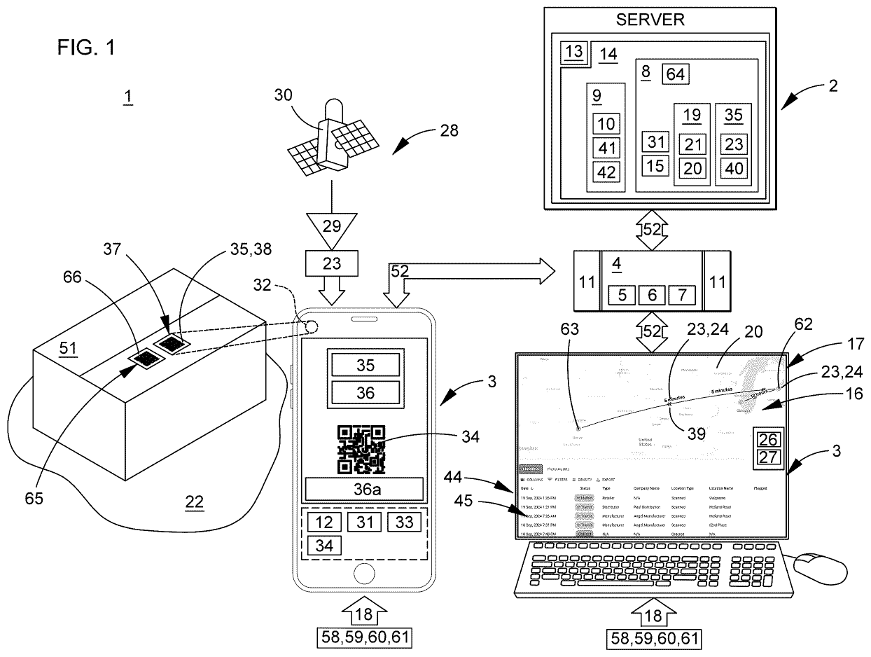

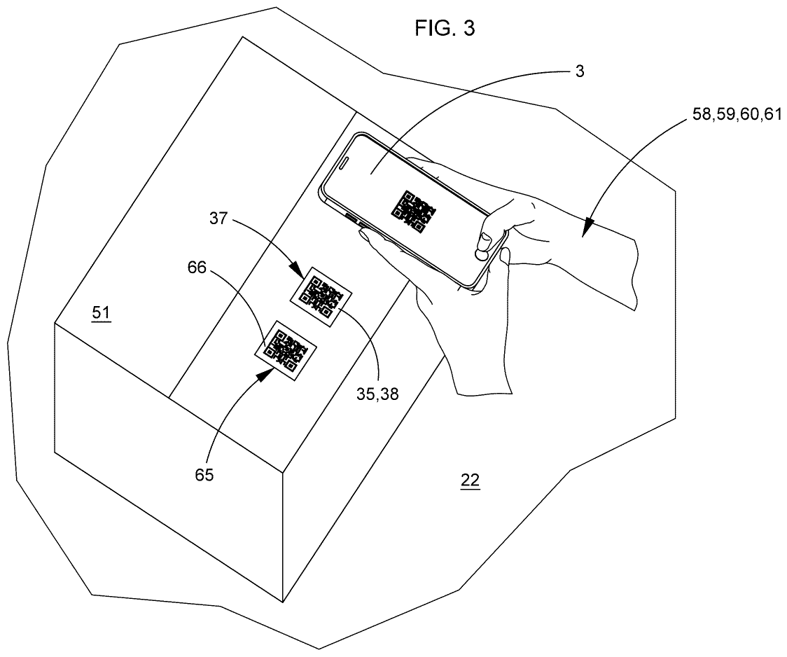

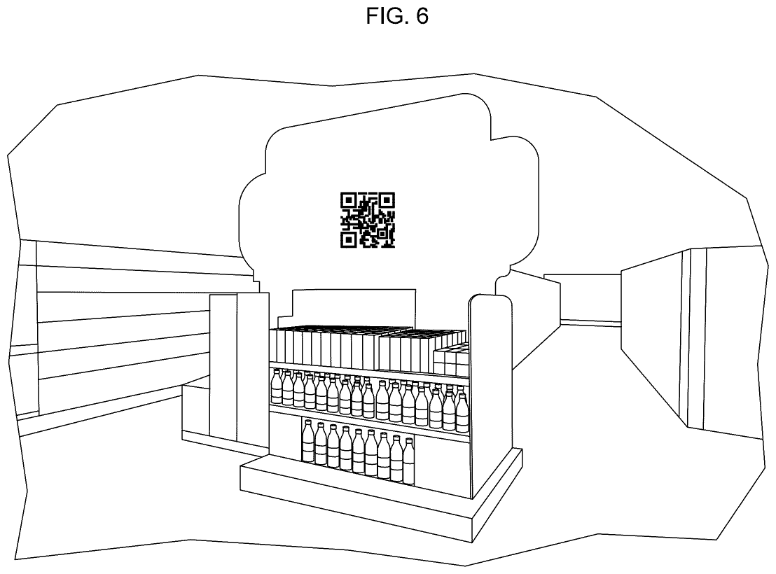

The System. Generally, with reference to FIGS. 1 through 6, a computer implemented system (1) (also referred to as the “system”) can be distributed on one or more servers (2) operably coupled to one or more user computing devices (3) directly or by a public network (4), such as the Internet (5), a cellular-based wireless network(s) (6), or a local network (7) (individually or collectively the “network”). While the term “user computing device” may be utilized in association with certain embodiments, this is not intended to limit the scope of the invention to those particular embodiments, rather certain embodiments may generically include a first computing device, a second computing device (3) through n . . . computing devices operably coupled or communicating as above described and as depicted in the FIG. 1 with “arrows” indicating the operable coupling or communication within the network (4). In particular embodiments, the system (1) can further comprise an asset tracking program (8) (also referred to as the “program”) including an asset tracker database (9) from which asset tracking records (10) can be retrieved by a request from any of the user computing devices (3) to the extent the user computing devices (3) have system (1) or asset tracking program (8) access privileges to retrieve system content (11) including, but not limited to, the asset tracking records (10).

Now, with primary reference to FIG. 1, depicting illustrative computer hardware, network elements, and computer readable media which can be utilized to practice embodiments of the system (1). It is not intended that embodiments of the invention be practiced in only wide area computing environments or only in local computing environments, but rather the invention can be practiced in local computing environments or in distributed computing environments where functions or tasks are performed by remote processing devices that are linked through a communications network (4). In a distributed computing environment, the program (1) may be located in a local or in remote memory storage device(s).

Also, while embodiments of the invention may be described in the general context of computer-executable instructions such as an application program and program modules which utilize routines, programs, objects, components, data structures, or the like, to perform particular functions or tasks or implement particular abstract data types being executed by the computer hardware and network elements, it is not intended that embodiments of the invention be limited to a particular set of computer-executable instructions or protocols.

Again, with primary reference to FIG. 1, one or more user computing devices (3) can be configured to connect with one or more server computers (2) through a wide area network (“WAN”), such as the Internet (5), or one or more cellular-based networks (6), or one or more local area networks (7) to transfer system content (11), including computer data processed or stored by a computer including, but not necessarily limited to text documents, images, audio clips, software programs, or other types of data. The one or more user computing devices (3) can take the form of one or more limited-capability computers designed specifically for navigation on the Internet (5). Alternatively, the user computing devices (3) can be hand-held devices such as smart phones, slate or pad computers, personal digital assistants or camera/cell phones, or multiprocessor systems, microprocessor-based or programmable consumer electronics, network PCs, minicomputers, mainframe computers, or the like.

Again, with primary reference to FIG. 1, each of the user computing devices (3) can include an Internet browser (12) (also referred to as a “browser”) such as GOOGLE CHROME®, MOZILLA®, FIREFOX®, or the like, which functions to download and render multimedia content that is formatted in “hypertext markup language” (HTML). In this environment, the server computer (2) can include a server processor (13) communicatively coupled to a server non-transitory computer readable medium (14) containing the asset tracking program (8) operable to execute a graphical user interface module (15) to implement the most significant portions of an asset tracker graphical user interface (16) retrievable for display on a display surface (17) of the user computing devices (3). As to these embodiments, the asset tracking program (8) which implements the asset tracker graphical user interface (16) can be resident in one or more server computers (2), or the one or more user computing devices (3) which can operate a browser (12) to display downloaded system content (11) and to relay user inputs (18) back to the one or more server computers (2). The one or more server computers (2) can respond by formatting new screen displays for the respective asset tracker graphical user interface (16) and downloading them for display on the display surface (7) of the one or more user computing devices (3).

In other embodiments, the one or more server computers (2) can be used primarily as sources of system content (11), with primary responsibility for implementing the asset tracker graphical user interface (16) being placed upon each of the one or more user computing devices (3). As to these embodiments, each of the one or more user computing devices (3) can contain and run the appropriate portions of the asset tracking program (8) implementing the asset tracker graphical user interface (16), as further described below. The asset tracker graphical user interface (16) can be implemented using various technologies and different devices, depending on the preferences of the designer and the particular efficiencies desired for a given circumstance.

Again, with primary reference to FIG. 1, embodiments of the asset tracking program (8) can further include a geospatial representation module (19) which upon execution functions to retrieve and depict a geospatial representation (20) of a coordinate encoded geographic space (21) of the Earth's surface (22) in the graphical user interface (16) on the display surface (17) of a user computing device (3). The geographic representation (20) can take any viewable form having any number of dimensions, any manner of symmetry, geometric properties, whether finite or infinite. Typically, the geospatial representation (20) will be in the form of one or more of a graphical image, an aerial image, a satellite image, topography map, a geo-planar map, a photograph, whether in two or three dimensions. For example, the geospatial representation module (19) can access one or more server computers (2) which can serve, as examples: GOOGLE MAPS®, GOOGLE EARTH®, BING MAPS®, MAPQUEST®, ESRI ARCGIS®, or the like.

In the example provided by FIG. 1, the geospatial representation module (19) retrieves from a server computer (2) a coordinate encoded geographic space (21), whether in whole or in part, which can be continuous or discontinuous, and decodes the coordinate encoded geographic space (21) to display the geospatial representation (20) on the display surface (17) of the user computing device (3). The geographic representation (20) can be displayed as a three-dimensional image of a portion of the Earth's surface (22), including, at the displayed scale, roadways, manmade structures, or the like. As to particular embodiments, the geographic representation (20) can further display certain geographic and administrative boundaries such as such as states, counties, cities, towns or residential areas; however, it is not intended that embodiments of the geographic representation (20) necessarily include other than a graphical representation including a coordinate encoded geographic space (21) in which location coordinates (23) (X, Y or X, Y, Z) define a unique coordinate location (24) in the geospatial representation (20).

Again, with primary reference to FIG. 1, the geospatial representation module (19) can further include a navigation module (25) which upon execution can display a navigation controller (26) on the display surface (17) of the client user computing device (3). The geographical representation (16) displayed on the display surface (17) can be operably coupled to the navigation controller (26) to allow the geographic representation (20) to be directionally moved on the display surface (17) by user inputs (18) with the navigation controller (26) to display portions of the geographic representation (16) of the coordinate encoded geographic space (21) which at the displayed scale, lie outside of the geographic representation (20) displayed on the display surface (17). As to certain embodiments, the navigation controller (26) can be displayed in the form of arrows correspondingly pointing in one or more cardinal directions (North, East, South, West). An arrow by user input (18) activates the navigation module (25) to move the view of the geographic representation (20) directionally on the display surface (17).

The navigation controller (26) can further include an image scale control (27). The geographic representation (20) can be operably coupled to image scale control (27) to allow the geographic representation (20) to be increased or decreased in scale on the display surface (17). As to certain embodiments, the image scale control (27) can be displayed on the display surface (17) in the form of a slider element which can be dragged up or down to correspondingly increase or decrease the scale of the geographic representation displayed on the display surface (17) and can further include a plus icon or a minus icon which by user input (18) correspondingly increases or decreases scale of the geographic representation (20). However, these examples of directionally moving and altering scale of the geographic representation (20) are illustrative and other embodiments can allow the geographic representation (20) to be directionally moved or altered in scale by click event including one or more of key stroke, mouse drag, menu, toolbar, or the like.

Again, with primary reference to FIG. 1, the system (1) can include or access a global positioning system (28) capable of transmitting global positioning signals (29). The term global positioning system (28), for the purposes of this invention, means a plurality earth-orbiting satellites (30) transmitting global positioning signals (29) continuously towards the Earth (22). The one or more servers (2) or the user computing devices (3) can include a global positioning system module (31) that enables access to timing and location timing signals from the satellites (30) and uses distance calculations to provide real-time locational data to establish a coordinate location (24), including a longitude and a latitude, of one or more user computing devices (3) on or near the Earth's surface (22).

Again, with primary reference to FIG. 1, the one or more user computing devices (3) can include an image capture device (32). As illustrative examples, the image capture device (32) can comprise a user computing device camera, digital scanner, or Google Lens®. The image capture device (32) can be coupled to a digital converter (33) executable to digitally convert captured images (34) for display on the display surface (17) of the user computing device (3). The one or more user computing devices (3) can further include a scanner application (34) to allow the user computing device (3) to scan codes (35). As illustrative examples, the codes (35) can be Universal Product Codes, European Article Number, code 39, code 128, quick response code (“QR code”) and data matrix. These codes (35), once scanned by a user computing device (3) can display scan code data (35) on the display surface (17) of the user computing device (3) or provide links (36′) to scan code data (35) or other computer applications. The links (36a) can comprise a uniform resource locator, short message service, or similar links to information.

Again, with primary reference to FIGS. 1 through 3, in particular embodiments, one or more codes (35) can be incorporated into one or more asset trackers (37). In the example of a QR code (38), the QR code (38) can be incorporated into one or more asset trackers (37). The QR code (38) or other code can be scanned by the user computing device (3) using the scanner application (34). The asset tracking program (8) can further operate to associate the current code scan data (35) with the current GPS coordinate location (24). The code scan data (35) associated with the GPS coordinate location (24) can be saved in the user computing device (3) scanning the code (35, 38) on the asset tracker (37) or can be transmitted based on the link (36a) provided by code (35) to one or more servers (2) to be downloaded to one or more user computing devices (3).

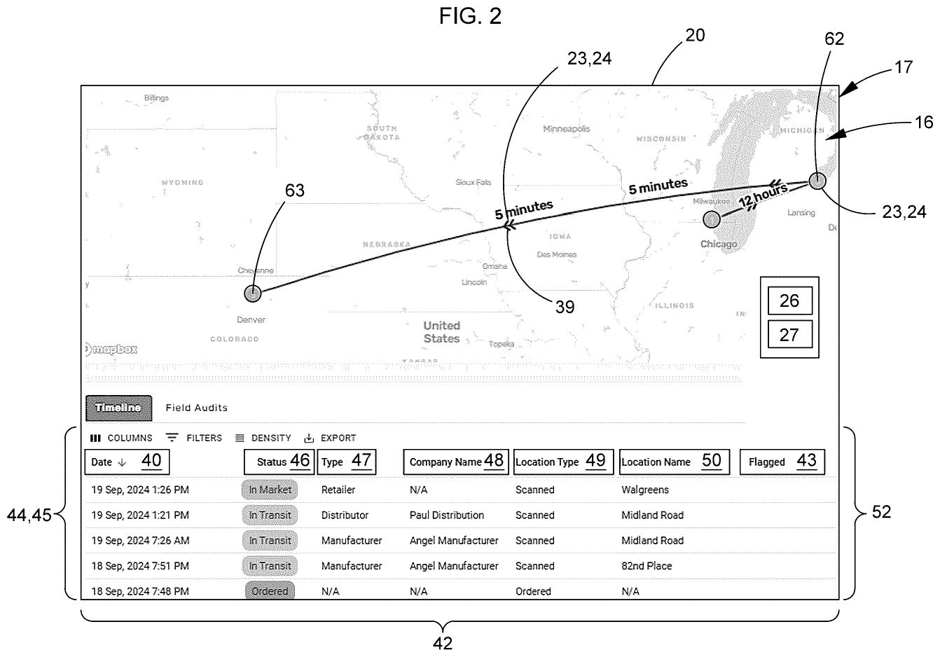

Again, with primary reference to FIGS. 1 through 3, the asset tracking program (8) can further operate to generate and display one or more coordinate location indicators (39) in the geographic representation (20) based on the global positioning location coordinates (23) associated with the code scan data (35) received directly or by way of the link (36a) generated upon scanning the code (35, 38) on the asset tracker (37). Thus, upon depiction of the geographic representation (20) on the display surface (17) of the user computing device (3), the asset tracking program (8) can further retrieve the code scan data (35) associated with global positioning location coordinates (23) and convert location coordinates (23) into coordinate location (24) in the coordinate encoded geographic space (21). The asset tracking program (8) can then generate and display a coordinate location indicator (39) at the corresponding coordinate location (24) (for example X, Y or X, Y, Z) in the geographic representation (20) and associate the location indicator (39) with a code scan date-time stamp (40). The asset tracking program (8) can further function to match the coordinate location (24) at which the asset tracker (37) was scanned with a corresponding asset tracking entity (41) in the asset tracker database (9) to retrieve asset tracking entity data (42) (including type of entity, name of entity, location of entity, scan, along with the date-time stamp (40). In the absence of a match of the coordinate location (24) to an asset tracking entity (41) in the asset tracker database (9), the asset tracking program (8) can generate the coordinate location indicator (39) at the corresponding coordinate location (24) in the geographic representation (20) with a date-time stamp (40) and generate and display an asset tracker flag (43) of the failure to associate the coordinate location (24) with a asset tracking entity (41). In particular embodiments, the asset tracker program (8) can generate and display an asset tracker dashboard (44) in the graphical user interface (16) on a display surface (17) of the user computing device (3). An illustrative example of the asset tracker dashboard (44) is depicted in FIG. 2, including the geographic representation (20) of a coordinate encoded geographic space (21) including coordinate location indicators (39) corresponding to coordinate locations (24) in the geographic representation (20) associated with the GPS location coordinates (23) afforded by the code scan data (35). In particular embodiments, the asset tracker program (8) can populate a columns and rows table (44) with the asset tracking entity data (42) including from left to right in the example of the asset tracker dashboard (44) the date-time stamp (40) at which the asset tracker was scanned, the status of the asset (46) (ordered, in-transit) being tracked, type of asset tracking entity (47) (client, manufacturer, distributor, retailer), name of the asset tracking entity (48), location type (49) (scanned, entered by user), location name of the asset tracking entity (50), and asset tracker flag (43). This illustrative example of graphical user interface (16) including the asset tracker dashboard (44) is not intended to prohibit other designs or presentation of the geographic representation, coordinate location indicators, or asset tracking entity data (42). Rather the illustrative example of the graphical user interface (16) and asset tracker dashboard (44) is intended to provide a person of ordinary skill in the art sufficient guidance to design and implement versions of a graphical user interface (16) including one or more of the above-described features.

Now, with primary reference to FIGS. 1 through 3, the term “asset (51)” for the purposes of this invention means any type of object including an asset tracker (37) containing a scannable code (35), and without limitation to the foregoing broad definition, an asset (51) including a tracker (37) can be can take the form of a package, a parcel, a box, a case, a bundle, a pack, a crate, packet, pouch which can be conveyed, moved or shipped in or between tiers of a supply chain, and which can contain an article of manufacture, and as illustrative examples can contain a product, product display, or point of sale display.

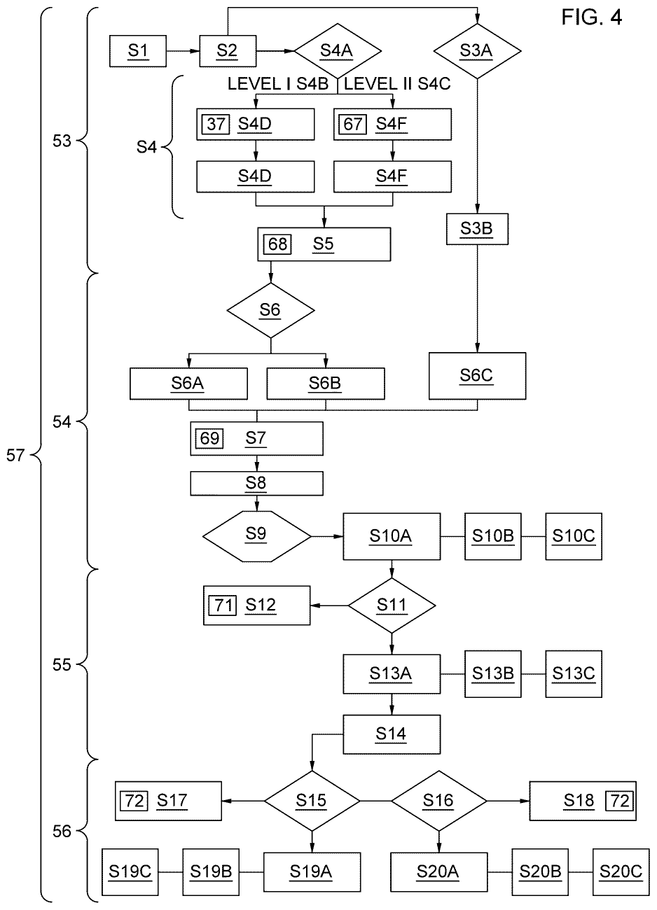

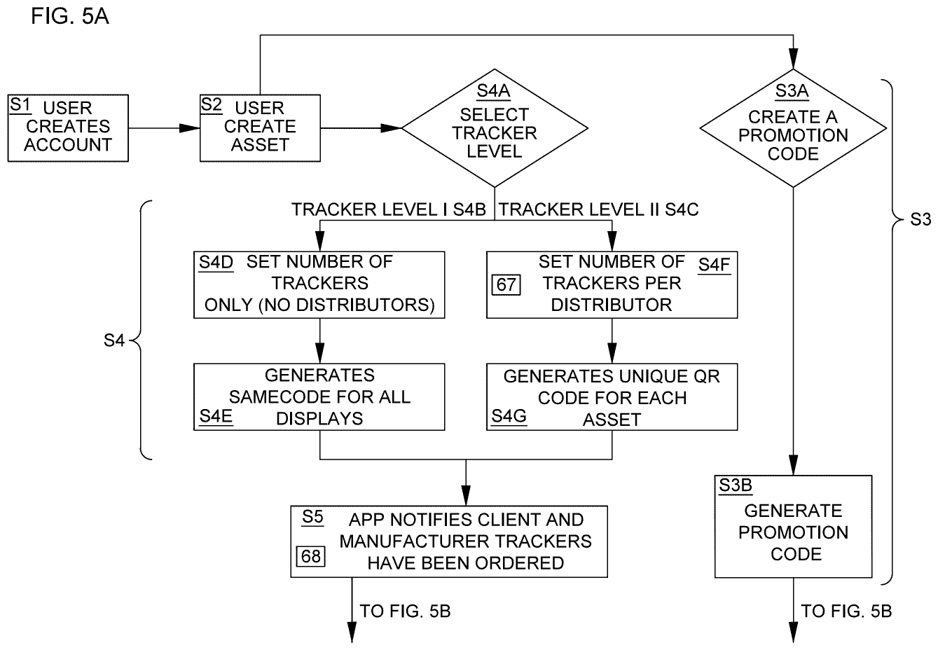

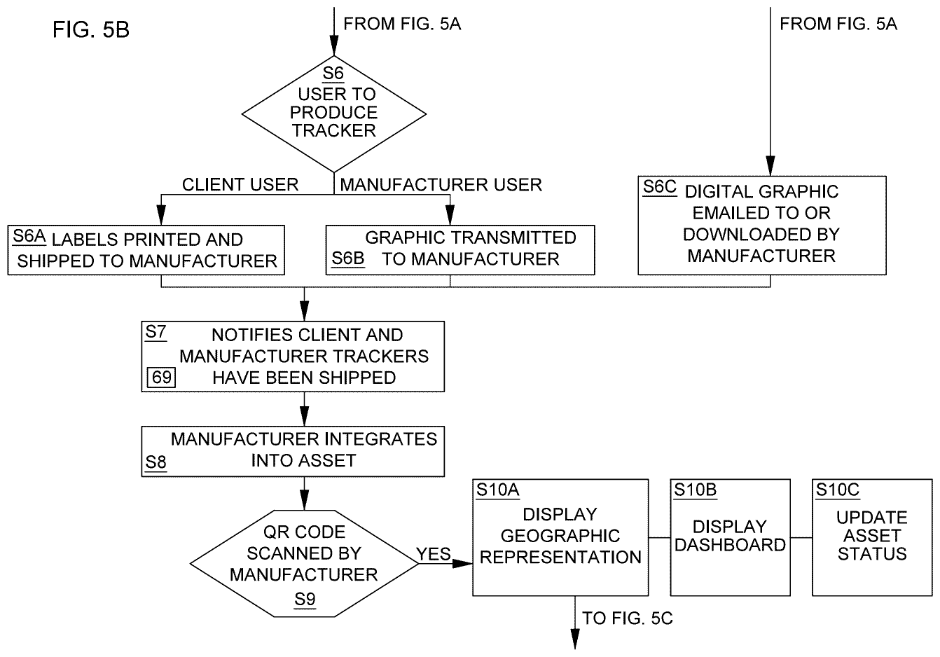

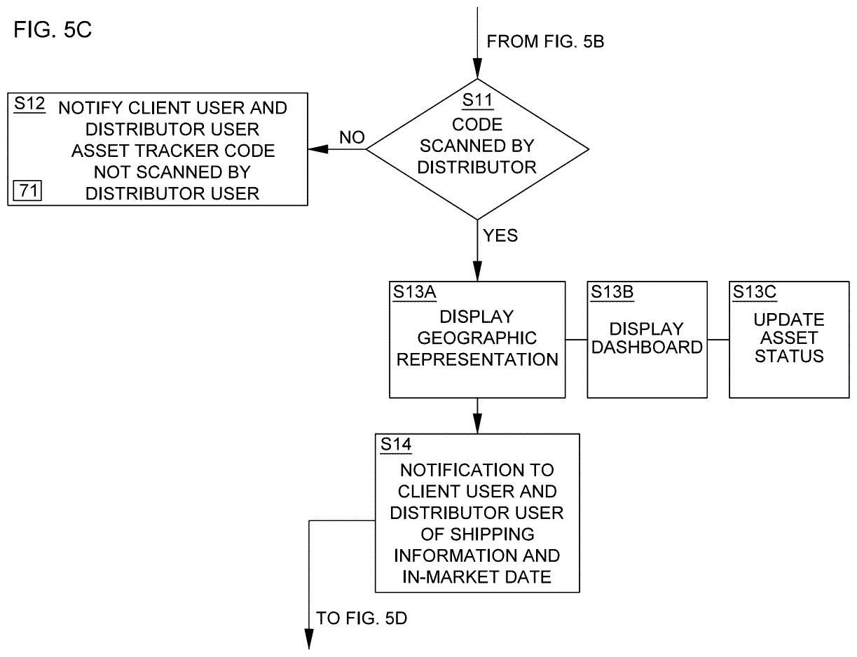

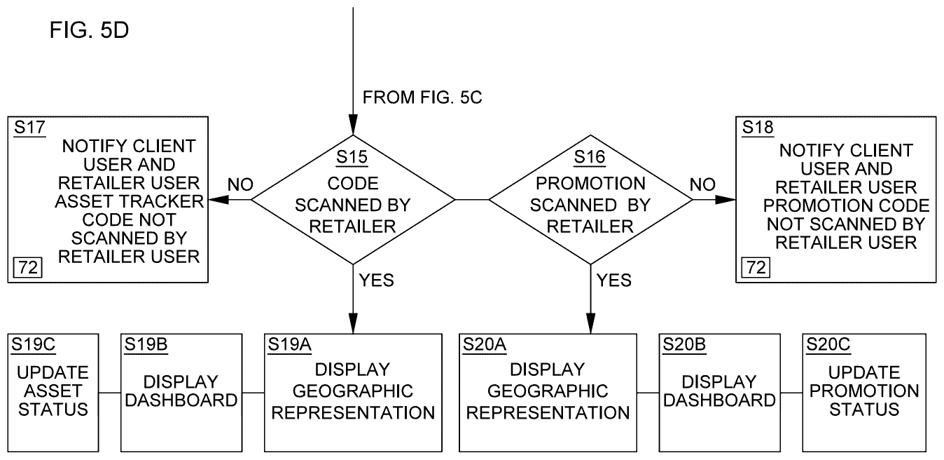

Now, with primary reference to FIGS. 4 and 5A through 5d, which depicts a block flow diagram which illustrates implementation of the supply chain asset tracking system (1) to increase asset information flow (52) associated with movement of an asset (51) in or between a plurality of tiers (53, 54, 55, 56) in a supply chain (57). While the illustrative example is provided in a four-tier supply chain (client tier (53); manufacturer tier (54); distributor tier (55), and retailer tier (56)) this is not intended to preclude embodiments of the system (1) useful to increase asset information flow (52) in a supply chain (57) having a greater or lesser number of tiers. The asset information flow (52) allows one or more user(s) (58, 59, 60, 61) whether a client user (58), a manufacture user (59), a distributor user (60), or retailer user (61) of the system (1) to monitor movement of one or assets (51) within or between a first location (62) and a second location (63) (as shown the example of FIG. 2) within a tier or between a plurality of tiers (58, 59, 60, and/or 61) in the supply chain (57). The system (1) operates to increase asset information flow (52) even in the event that different product identifiers are associated with each of a plurality of products at each the plurality of tiers (58, 59, 60, and/or 61) within the tiered supply chain (57).

The term “supply chain (57)” for the purposes of this invention means the logistics system that includes the facilities that convert raw materials into finished articles and distributes them to end consumers.

The term “client tier (53)” as used for the purposes of this invention means the tier within the supply chain in which an entity that uses the system (1) to create an asset tracking account (64), define an asset (51) and associate trackers (37) with the asset (51).

The term “manufacturer tier (54)” as used for the purposes of this invention means the tier within the supply chain (57) in which an entity makes or produces an asset (51).

The term “distributor tier (55)” as used for the purposes of this invention means the tier within the supply chain (57) in which an entity distributes assets (51) to a retailer tier (56) of the supply chain (57).

The term “retailer tier (56)” as used for the purposes of this invention means the tier in which an entity places assets in-market for consumer information or consumption.

Client Tier. Now, with primary reference to FIGS. 4 and 5A which depict an enlarged block flow diagram of an embodiment of the system process in a client tier (53) within the asset tracking system (1). The system process in the client tier (53) comprises one or more of:

Account Creation (S1) involves a client user (58) accessing the graphical user interface (16) of the asset tracking system (1), and by user interaction (18) opening the tracker account creation screen, enter an email address which the client user (58) can access, submit, receive a login email message, confirm client email address, follow prompts to enter a username and password to create a supply chain asset tracking account (64).

Asset Creation (S2) includes defining an asset (51) by client user interaction (18) in the graphical user interface (16) to enter the asset name, a request date, an asset life cycle, a target in-market date, a manufacturer name, and optionally entering one or more of an asset image, an asset type, an asset cost, an asset material, an asset campaign, an asset promotion code, a distributor incentive.

Promotion Creation (S3) includes client user interaction (18) in the graphical user interface (16) assigning a promotion to the asset (51) (S3A) which prompts the system (1) to create a promotion tracker (65) including a promotion code (66) (S3B).

Tracker Creation (S4) includes client user interaction (18) in the graphical user interface (16) selection of a tracker level (S4A) between a plurality of tracker levels (S4B, S4C . . . S4n) distinguished by the complexity of the supply chain (57) the asset (51) will move through. As an illustrative example, in tracker creation level I (S4B) there is no distributor tier (55) in the supply chain (57) and the manufacturer tier (54) ships an asset directly to the retailer tier (56). The client user (58) in tracker creation level I (S4B) enters the number of trackers (37) (S4D) corresponding to the number of assets (51) to be tracked from the manufacturer tier (54) to the retailer tier (56). All the trackers (51) in tracker creation level I (S4B) include the same scannable code (38) for all the assets (51) defined by the process of asset creation (S2). The system (1) generates the number trackers (37) entered by the client user (S4E). By way of comparison, a tracker creation level II (S4C) includes a distributor tier (55) in the supply chain (57) and the manufacturer tier (55) ships to one or more distributor users (60) in the distributor tier (55). The client user (58) enters the distributor identification data (67) and the number of trackers (37) to generate for each distributor (S4F). The system (1) generates the number trackers (37) entered by the client user (38) for each identified distributor user (60) (S4G).

Client Notification (S5) includes a tracker creation electronic notification (68) generated by the system (1) to the client user (58) and the manufacturer user (59) that the asset trackers (51) have been generated by the system (1).

Manufacturer Tier. Now, with primary reference to FIGS. 4 and 5B which depicts an enlarged block flow diagram of an embodiment of the system process in the manufacturer tier (54) within the supply chain (57). The system process within the manufacturer tier (54) includes one or more of:

Tracker Production in the manufacturer tier (54) includes a tracker production decision as to which of the client user (58) or the manufacturer user (59) will produce the trackers (37) (S6) which can be affixed or integrated with the asset (51). As an illustrative example, physical asset trackers (37) including a scannable code (38) can be produced by the client user (58) and shipped to the manufacturer user (S6A). As an alternative, the system (1) can generate an electronic graphic of the trackers (37) including the scannable code (38) and forward the electronic graphic of the trackers (37) to the manufacturer user (59) (S6B) from which the manufacturer user (59) can produce the trackers (37) to affix or integrate with the asset (51). Similarly, in regard to promotion trackers (65), the client user (38) can produce a physical promotion trackers (65) and ship physical promotion trackers (65) to the manufacturer user (59), or the system (1) can generate a electronic graphic of the promotion trackers (65) and forward the electronic graphic of the promotion trackers (65) to the manufacturer user (54) (S6C) from which the manufacturer user (54) can produce the promotion trackers (65) to affix or integrate with the asset (51).

Tracker Shipment Notification (S7) in the manufacturer tier (54) includes a tracker shipment electronic notification (69) by the system (1) to the manufacture user (59) that the physical trackers (37) have been created by the client user (58) and have been shipped to the manufacturer user (59) or that the electronic graphic of the trackers (37) have been electronically sent to the manufacturer user (59).

Tracker Tag Integrated with Asset (S8) in the manufacturer tier (54) includes the manufacturer user (59) affixing or otherwise integrating the asset tracker (37) with the asset (51). In regard to physical trackers (37) including the scannable code (38), the affixation or integration can be accomplished in any manner that maintains the asset tracker (37) with the asset (51) during transit from the manufacturer tier (54) to the retailer tier (56) in the supply chain (57). As illustrative examples, the asset tracker (37) can be affixed or integrated to the asset (51) by one or more adhesives, such as: hot glue, white glue, craft glue, spray adhesive; or overlaid or underlaid by an adhesive tape, such as: single sided packaging tape, double sided tape, and foam tape; applied by label applicator, or the like. In regard to electronic graphic trackers (37) including the scannable code (38), affixing or integrating the electronic graphic tracker (37) can be accomplished by producing physical trackers (37) which can be adhered to the asset (51) as above described, or converted to digital instructions to actuate printers, laser printers, laser etchers, thermal printers to directly mark the asset (51), or combination of the above.

Tracker Scanned by Manufacturer User (59) in the Manufacturer Tier (54) (S9). The asset tracker (37) having the code (38) can be scanned by the manufacturer user (54) to associate the instant code scan data (35) with the instant GPS coordinate location (24) of the asset (51) along with the date-time stamp (40). The code scan data (35) associated with the GPS coordinate location (24) can be saved in the user computing device (3) or can be transmitted based on the link (36a) provided by code (38) to one or more servers (2) to be downloaded to the computing device (3) of the client user (58) and/or other user computing device. The system (1) can further operate to generate and display the geographic representation (20) including one or more coordinate location indicators (39) based on the global positioning location coordinates (23) associated with the code scan data (35) received directly or by way of the link (36a) generated upon scanning the code (38) on the asset tracker (S10A). The asset tracker program (8) can generate and display the asset tracker dashboard (44) in the graphical user interface (16) on a display surface (17) of the computing device (3) of the client user (58) (S10B). The asset tracker program (8) can update the dashboard (44) columns and rows table (45) with the with updated the date-time stamp (40) at which the asset tracker (37) was scanned, the status of the asset (46) being tracked (displayed as “In Transit”), type of asset tracking entity (47) (“Manufacturer”), name of the asset tracking entity (48) (“Name of Manufacturer”), location name (50) of the asset tracking entity (48), and asset tracker flag (43) (S10C).

Distributor Tier. Now, with primary reference to FIGS. 4 and 5C which depicts an enlarged block flow diagram of an embodiment of the system process in the distributor tier (55) within the asset tracking system (1). The system process within the distributer tier (55) includes one or more of:

Tracker Scanned by Distributor User in the Distributor Tier. The distributor user (60), upon receipt of the asset (51) can scan the asset tracker (37) (S11). The asset tracker (37) having the code (38) scanned by the distributor user (60) associates the instant code scan data (35) with the instant GPS coordinate location (24) of the asset (51) along with the date-time stamp (40). In the event that the asset tracker (37) is not scanned within threshold time period or a pre-selected time period the tracker program (8), can operate to generate a distributor scan tracker electronic notification (70) to the distributor user (60) and/or the client user (58) that the asset tracker (37) was not scanned by the distributor user (60) and to scan the asset tracker (37) (S12). The code scan data (35) associated with the GPS coordinate location (24) can be saved in the user computing device (3) scanning the code (38) or can be transmitted based on the link (36a) provided by code (38) to one or more servers (2) to be downloaded to the computing device (3) of the client user (58) (S13A). The system (1) can further operate to generate and display the geographic representation (16) including one or more coordinate location indicators (39) based on the global positioning location coordinates (23) associated with the code scan data (35) received directly or by way of the link (36a) generated upon scanning the code (38) on the asset tracker (S13B). The asset tracker program (8) can generate and display the asset tracker dashboard (44) in the graphical user interface (16) on a display surface (17) of a user computing device (44) (S13C). The asset tracker program (8) can update the dashboard (44) columns and rows table (45) with the date-time stamp (40) at which the asset tracker was scanned by the distributor user (60), the status of the asset (46) being tracked (displayed as “In Transit”), type of asset tracking entity (47) (“Distributor”), name of the asset tracking entity (48) (“Name of Distributor”), location name (50) of the asset tracking entity, and asset tracker flag (43).

In-Market Date and Shipping Notification. In particular embodiments, the system (1) operates to generate an in-market electronic notification (71) to the distributor user (60) and the client user (58) in advance of the in-market date for the asset (51) along with the shipping information of retailer user(s) (61) receiving the asset (51) (S14). The term “in-market date” for the purposes of this invention means the date on which the asset (51) is to be available to the retailer tier (56) to display or offer to the consuming public. As an illustrative example, the days of advance notice to the distributor user (60) can be a fixed number of days or a pre-selected number of days entered into the system (1) by the client user (58), such as fourteen days in advance of the in-market date. The in-market electronic notification (71) can include shipping information of retailer user (61) including but not limited to: the retailer name, retailer address, in-market date.

Retailer Tier. Now, with primary reference to FIGS. 4 and 5D which depict an enlarged block flow diagram of an embodiment of the system process in the retailer tier (56) within the asset tracking system (1). The system process within the retailer tier (56) includes one or more of:

Tracker Tag Scanned by Retailer in the Retailer Tier. The retailer user (61), upon receipt of the asset (51) can scan the asset tracker (51) (S15). The asset tracker (51) having the code (38) scanned by the retailer user (61) associates the code scan data (35) with the instant GPS coordinate location (24) of the asset (41) along with the date-time stamp (40). In particular embodiments, the retailer user (61), upon receipt of the asset (51) can further scan the promotion tracker (65) (S16). In the event that the asset tracker (37) is not scanned by the retailer user (61) within a threshold time period or pre-selected time period the tracker program (8), can operate to generate a retailer scan tracker electronic notification (72) to the retailer user (61) and/or the client user (58) that the asset tracker (37) was not scanned by the retailer user (61) and to scan the asset tracker (51) (S17). In the event that the promotion tracker (65) is not scanned by the retailer user (61) within a threshold period of time or a pre-selected time the tracker program (8), can operate to generate an retailer scan promotion electronic notification (72) to the retailer user (61) and/or the client user (58) that the promotion tracker (65) was not scanned by the retailer user (61) and to scan the tracker and/or the promotion tracker (65) (S18). The code scan data (35) associated with the GPS coordinate location (24) can be saved in the computing device (3) scanning the code (38) on the asset tracker (37) or can be transmitted based on the link (36a) provided by the code (38) to one or more servers (2) to be downloaded to the computing device (3) of the client user (58) and/or other user computing device (S19A). The system (1) can further operate to generate the geographic representation (16) and display one or more coordinate location indicators (39) in the geographic representation (15) based on the global positioning coordinate location (24) associated with the code scan data (35) received directly or by way of the link (36a) generated upon scanning the code (38) on the asset tracker (37) (S19B). Similarly, the promotion code scan data (36) associated with the GPS coordinate location (24) can be saved in the computing device (3) scanning the code (38) on the asset tracker (37) or can be transmitted based on the link (36a) provided by the code (38) to one or more servers (2) to be downloaded to the computing device (3) of the client user (58) and/or other user computing device (S20A). The system (1) can further operate to generate and display one or more coordinate location indicators (39) in the geographic representation (16) based on the global positioning coordinate location (24) associated with the code scan data (35) integrated in the promotion tracker (65) received directly or by way of the link (36a) generated upon scanning the promotion code (66) on the promotion tracker (S22B). The asset tracker program (8) can generate and display the asset tracker dashboard (44) in the graphical user interface (16) on a display surface (17) of the client user (58) computing device (3) or other user computing device based on the code scan data (35) (S21C) or the promotion code scan data (36) (S22C). The asset tracker program (8) can update the dashboard (44) columns and rows table (45) with the with updated the date-time stamp (40) at which the asset tracker (37) or the promotion tracker (65), or both, was scanned; the status of the asset (46) being tracked (displayed as “In Market”), type of asset tracking entity (47) (“Retailer”), name of the asset tracking entity (48) (“Name of retailer”), location name (50) of the asset tracking entity, and asset tracker flag (43).

As can be easily understood from the foregoing, the basic concepts of the present invention may be embodied in a variety of ways. The invention involves numerous and varied embodiments of a supply chain asset tracking system and methods for making and using such supply chain tracking system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “tracker” should be understood to encompass disclosure of the act of “tracking”—whether explicitly discussed or not—and, conversely, were there is a disclosure of the act of “tracking”, such a disclosure should be understood to encompass disclosure of a “tracker” and even a “means for tracking”. Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the supply chain tracking systems or trackers herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

I claim:

1. A supply chain asset tracking system, comprising:
an asset;
an asset tracker integrated with said asset, said asset tracker including a code scannable with a code reader;
a processor communicatively coupled to a non-transitory computer readable medium containing an asset tracking program executable to:
generate code scan data based on scan of said code included with said tracker;
obtain global positioning data from a global positioning system;
associate said global positioning data with said code scan data;
display a graphical user interface on a display surface of a user computing device, including:
a geographic representation of a coordinate encoded geographic space;
a coordinate location indicator disposed in said geographic representation at a coordinate location of said asset based on said global positioning data;
extract asset tracker entity data from said code scan data;
display an asset tracker dashboard; and
populate said asset tracker dashboard with said asset tracker entity data.

2. The system of claim 1, wherein said asset tracking program is further executable to display in said graphical user interface a client account creation screen which by user interaction receives client data to define a client user in a client tier of said supply chain.

3. The system of claim 2, wherein said asset tracking program is further executable to display an asset creation screen which by user interaction receives asset data to define said asset.

4. The system of claim 3, wherein said asset tracking program is further executable to create said code including said client data and said asset data.

5. The system of claim 4, wherein said asset tracking program is further executable to generate said asset tracker with said code including said client data and said asset data.

6. The system of claim 5, wherein said asset tracking program is further executable to generate an electronic notification of asset tracker production to said client user in said client tier of said supply chain.

7. The system of claim 6, wherein said asset tracking program is further executable to generate said electronic notification of said asset tracker production to a manufacturer user in a manufacturer tier of said supply chain.

8. The system of claim 7, wherein said asset tracking program is further executable to actuate a printer to print said asset tracker with said code including said client data and said asset data, wherein said client user in said client tier of said supply chain ships said asset tracker to said manufacturer user in said manufacturer tier of said supply chain.

9. The system of claim 8, wherein said asset tracking program is further executable by client user interaction in said graphical user interface to transmit an electronic graphic of said asset tracker to said manufacturer user in said manufacturer tie of said supply chain.

10. The system of claim 9, wherein said asset tracking program is further executable by manufacturer user interaction in said graphical user interface to actuate a printer to print said asset tracker with said code including said client data and said asset data based on said electronic graphic of said tracker.

11. The system of claim 10, wherein said asset tracker integrated with said asset by said manufacturer user in said manufacturer tier of said supply chain.

12. The system of claim 11, wherein said asset tracker scanned by said manufacturer user in said manufacturer tier of said supply chain.

13. The system of claim 12, wherein said asset tracking program further executable to dispose a manufacturer coordinate location indicator in said geographic representation of said coordinate encoded geographic space and populates said tracker dashboard with said asset tracker entity data of said manufacturer user.

14. The system of claim 13, wherein said asset integrated with said asset tracker transported from said manufacturer in said manufacture tier of said supply chain to a distributor in said distributor tier in said supply chain.

15. The system of claim 14, wherein said asset tracker scanned by a distributor user in said distributor tier of said supply chain.

16. The system of claim 15, wherein said asset tracking program is further executable to dispose a distributor coordinate location indicator in said geographic representation of said coordinate encoded geographic space and populates said tracker dashboard with said asset tracker entity data of said distributor user.

17. The system of claim 16, wherein said asset integrated with said asset tracker transported from said distributor in said distributor tier to a retailer in said retailer tier in said supply chain.

18. The system of claim 17, wherein said asset tracker scanned by said retailer user in said retailer tier of said supply chain.

19. The system of claim 18, wherein said asset tracking program is further executable to dispose a retailer coordinate location indicator in said geographic representation of said coordinate encoded geographic space and populates said tracker dashboard with said asset tracker entity data of said retailer user.

20. A method of making a supply chain asset tracking system, comprising:
producing an asset tracker integratable with an asset, said asset tracker including a code scannable with a code reader;
communicatively coupling a processor to a non-transitory computer readable medium containing an asset tracking program executable to:
generate code scan data based on scan of said code included with said tracker;
obtain global positioning data from a global positioning system;
associate said global positioning data with said code scan data;
display a graphical user interface on a display surface of a user computing device, including:
a geographic representation of a coordinate encoded geographic space;
a coordinate location indicator disposed in said geographic representation at a coordinate location of said asset based on said global positioning data;
extract asset tracker entity data from said code scan data;
display an asset tracker dashboard; and
populate said asset tracker dashboard with said asset tracker entity data.

21. A method of asset tracking in a supply chain, comprising:
integrating an asset tracker with an asset, said asset tracker including a code scannable with a code reader;
operating a client user computing device including a processor communicatively coupled to a non-transitory computer readable medium containing an asset tracking program;
generating a code scan data based on said code included in said tracker;
obtaining global positioning data from a global positioning system;
associating said global positioning data with said code scan data;
displaying a graphical user interface on a display surface of a user computing device, including:
a geographic representation of a coordinate encoded geographic space;
a coordinate location indicator disposed in said geographic representation at a coordinate location of said asset based on said global positioning data;
extracting asset tracker entity data from said code scan data;
displaying an asset tracker dashboard; and
populating said asset tracker dashboard with said asset tracker entity data.
